(19) United States
(12) Patent Application Publication
(10) Pub. No.: US 2010/0104236 A1
(43) Pub. Date: Apr. 29, 2010

(54) WIDE BAND MICROWAVE PHASE SHIFTER

(76) Inventor: Brian G. Keating, La Jolla, CA (US)

Correspondence Address: Hiscock & Barclay, LLP, One Park Place, 300 South State Street, Syracuse, NY, 13202-2078, US

(21) Appl. No.: 12/259,672

(22) Filed: Oct. 28, 2008

(51) Int. Cl. G02B 6/00; G02B 27/00

(52) U.S. Cl. 385/11; 359/577

(57) ABSTRACT

The invention relates to a phase shifting device for switching the polarization state of an electromagnetic wave. Two waveguide sections have an exterior rectangular opening defined in their end surfaces. A dielectric break is situated substantially collinearly with the longitudinal axis of the waveguide in substantially a center of the waveguide. In one embodiment, a central structure includes a cylinder having a permeability greater than that of a vacuum, and having two substantially circular end faces situated in perpendicular orientation to a longitudinal axis of the cylinder and two dielectric cones. A magnetic field source switches a polarization of the electromagnetic wave causing a phase shift of the electromagnetic wave of substantially zero degrees when the controllable magnetic field is off and a pre-determined phase shift when the controllable magnetic field is on. The invention can be used in an interferometer apparatus and a phased array apparatus.

### FIELD OF THE INVENTION

This invention relates generally to a phase shifter and more particularly to a wide-band microwave and mm-wavelength phase shifter.

### BACKGROUND OF THE INVENTION

Astrophysical study of the formation of galaxies and stars and observation and mapping of other astrophysical phenomena is performed in large part by detection of radiation at wavelengths in the microwave and millimeter-wave spectrum. An important tool in the detection of such radiation involves feed horn coupled bolometric detector arrays mounted on satellites or space observatories. Input side components of such detectors, include component blocks such as amplifiers, waveguides, and phase shifters. The input side components are typically maintained at cryogenic temperatures to reduce system noise.

Bolometric detector arrays present particular challenges in fabrication due to the need for operation over large temperature ranges. Existing stripline technologies and solid state switches are not suitable for use over the wide temperature ranges needed for proper bolometric detector operation. For example, suspended stripline phase shifters can only be used with a coherent microwave amplifier preceding the device. Such stripline technologies, which exhibit high loss and cause injection of additional noise, are of limited use in astrophysical applications. Also, as discussed above, sensitive bolometric detectors are incompatible with microwave amplifiers. One example of a solid state switch was provided by Jarosik et al (Design, Implementation, and Testing of the Microwave Anisotropy Probe Radiometers, Astrophysical Journal, Supplement, Series, 145:413-436, April 2003). The devices Jarosik described cannot function below ˜140 K. At 140 K, if Jarosik's devices were to be used with a bolometric detector, they could produce a spurious signal nearly 20 times brighter than the desired science signal.

There is a need for a device that can operate over a temperature range from over 300 K down to below 3 K and that can be used with a bolometer or a coherent microwave amplifier.

### SUMMARY OF THE INVENTION

In one aspect, the invention relates to a phase shifting device for switching the polarization state of an electromagnetic wave that includes a waveguide having two waveguide sections. Each waveguide section has an exterior rectangular opening defined in an end surface thereof and has an interior opening of predefined cross-sectional shape defined within a body thereof. The exterior rectangular opening and the interior opening of predefined cross-sectional shape are situated along a longitudinal axis of the waveguide. The waveguide sections are separated by a dielectric break. The dielectric break is defined therein and situated substantially collinearly with the longitudinal axis of the waveguide in substantially a center of the waveguide. The phase shifting device also includes a central structure situated along the longitudinal axis of the waveguide. The central structure includes a cylinder having a permeability greater than that of vacuum. The cylinder has two substantially circular end faces situated in perpendicular orientation to a longitudinal axis of the cylinder, and two dielectric cones. Each of the dielectric cones has a base mechanically coupled to an end face of the cylinder and a cone axis situated substantially collinearly with the longitudinal axis of the cylinder. The central structure is supported substantially in the center of the interior opening of predefined cross-sectional shape of the waveguide. The cylinder is substantially situated within the dielectric break of the waveguide. The phase shifting device also includes a magnetic field source. The magnetic field source is configured to generate a controllable magnetic field in the cylinder, wherein the magnetic field switches a polarization of the electromagnetic wave causing a phase shift of the electromagnetic wave of substantially zero degrees when the controllable magnetic field is off and a pre-determined phase shift when the controllable magnetic field is on.

In one embodiment, the interior opening of predefined cross-sectional shape is a circular opening.

In another embodiment, the pre-determined phase shift is substantially 180 degrees.

In yet another embodiment, the pre-determined phase shift is constant to within 1 degree over a 30% or greater fractional bandwidth.

In yet another embodiment, the waveguide includes gold plated copper.

In yet another embodiment, the waveguide includes a superconductor material.

In yet another embodiment, the central structure is supported by one or more dielectric supports.

In yet another embodiment, the one or more dielectric supports include one or more silica washers.

In yet another embodiment, the ceramic cones include an alumina ceramic.

In yet another embodiment, the each of the ceramic cones further include a sheet of microwave absorbing material and each of the sheets of microwave absorbing material are oriented substantially at 90 degrees with respect to the other along a longitudinal axis of the cylinder.

In yet another embodiment, the device further comprises a microwave absorber.

In yet another embodiment, the dielectric break is coated with a microwave absorber.

In yet another embodiment, the solenoid has solenoid windings includes a selected one of metallic windings and superconducting windings.

In yet another embodiment, the dielectric cylinder includes a ceramic or a semiconductor.

In yet another embodiment, the ceramic includes a ferrite ceramic.

In yet another embodiment, the semiconductor includes germanium or garnet.

In another aspect, an interferometer apparatus for strongly enhancing signal reception of an incident electromagnetic wave from a particular direction includes two or more receiving structures to guide the incident electromagnetic wave into the interferometer apparatus. The interferometer apparatus also includes two or more phase shifting devices as described above, each phase shifting device coupled to one each of the receiving structures. The interferometer apparatus also includes two or more detectors coupled to a respective one of the output structures of the two or more phase shifting devices, each detector having a detector electrical output terminal. The interferometer apparatus also includes a processor configured to receive an output signal from each of the detector electrical output terminals, wherein the output signals can be combined and processed to strongly enhance the incident electromagnetic wave from a particular direction.

In one embodiment, at least one of the two or more detectors includes a bolometer.

In another embodiment, at least one of the two or more detectors includes a microwave amplifier.

In yet another embodiment, at least one of the two or more detectors includes a SIS mixer.

In yet another embodiment, the detector is cooled to a temperature below 100 K.

In yet another embodiment, the magnetic field source is an electrical solenoid.

In yet another embodiment, the electrical solenoid includes superconducting windings.

In yet another embodiment, the at least one of the two or more receiving structures and the output structure includes a microwave feedhorn.

In another aspect, a phased array apparatus for transmitting an electromagnetic wave in a particular direction includes two or more input structures, each of the input structures configured to accept an electromagnetic wave to be transmitted by the phased array apparatus in a particular direction. The phased array apparatus also includes two or more phase shifting devices as described above, each phase shifting device coupled to one of the input structures to receive an input signal therefrom and configured to provide as output a respective phase shifted output signal. The phased array apparatus also includes two or more transmitting structures, each of the transmitting structures operatively connected to a respective one of the phase shifting devices and configured to receive as input a respective phase shifted output signal from a respective one of the phase shifting devices, and configured to guide the phase shifted output signal from the phase shifting device into a transmission medium.

In one embodiment, the two or more transmitting structures include planar antennae.

In yet another aspect, a phase shifting device for switching the polarization state of an electromagnetic wave includes a waveguide having two waveguide sections. Each waveguide section has an exterior rectangular opening defined in an end surface thereof and has an interior opening of predefined cross-sectional shape defined within a body thereof. The exterior rectangular opening and the interior opening of predefined cross-sectional shape is situated along a longitudinal axis of the waveguide. The waveguide sections are separated by a dielectric break. The dielectric break is defined therein and situated substantially collinearly with the longitudinal axis of the waveguide in substantially a center of the waveguide. The phase shifting device for switching the polarization state of an electromagnetic wave also includes a central structure situated along the longitudinal axis of the waveguide. The central structure includes a structure having a cross section including a polygon having N sides (where N is an integer) having a permeability greater than that of vacuum. The structure has a cross section including a polygon having N sides having two end faces situated in perpendicular orientation to a longitudinal axis of the structure having a cross section including a polygon having N sides, and two dielectric pyramidal structures having N sides. Each of the dielectric pyramidal structures has N sides that have a base mechanically coupled to an end face of the structure having a cross section including a polygon having N sides and having an axis situated substantially collinearly with the longitudinal axis of the structure having a cross section including a polygon having N sides. The central structure is supported substantially in the center of the interior opening of predefined cross-sectional shape of the waveguide. The structure has a cross section including a polygon having N sides substantially situated within the dielectric break of the waveguide. The phase shifting device for switching the polarization state of an electromagnetic wave also includes a magnetic field source. The magnetic field source is configured to generate a controllable magnetic field in the structure having a cross section including a polygon having N sides, wherein the magnetic field switches a polarization of the electromagnetic wave causing a phase shift of the electromagnetic wave of substantially zero degrees when the controllable magnetic field is off and a pre-determined phase shift when the controllable magnetic field is on.

In one embodiment, N equals 4.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A shows a schematic diagram of one exemplary embodiment of a 180° phase shifter according to the present invention.

FIG. 1B shows an end on view of a rectangular waveguide port.

FIG. 1C shows a cutaway end view looking onto the tip of a toothpick.

FIG. 2 shows an exemplary embodiment of a phase shifter solenoid.

FIG. 3A shows a black and white rendition of an exemplary toothpick.

FIG. 3B shows a toothpick with a sheet of metal in each cone.

FIG. 3C shows a representative end on view of the toothpick of FIG. 3B to illustrate the relative orientation of two exemplary material layers.

FIG. 4 shows one embodiment of a disassembled Faraday rotation switch (FRS).

FIG. 5 shows one embodiment of a waveguide assembly of an FRS.

FIG. 6 shows a simplified diagram of a side view of an FRS such as shown in FIG. 4.

FIG. 7A shows an oblique view of an exemplary 100 GHz FRS.

FIG. 7B shows a side view of the FRS of FIG. 7A.

FIG. 7C shows an input flange view of the FRS of FIG. 7A.

FIG. 7D shows an output flange view of the FRS of FIG. 7A.

FIG. 8A shows a diagram of a −90 degree electric field rotation.

FIG. 8B shows a diagram of a +90 degree electric field rotation.

FIG. 9 shows a graph of insertion loss for a 100 GHz FRS.

FIG. 10 shows a FRS transmission switch ratio graph.

FIG. 11 shows a graph of reflection vs. solenoid current for an exemplary FRS.

FIG. 12 shows a block diagram of an exemplary FRS interferometer.

### DETAILED DESCRIPTION OF THE INVENTION

The inventive phase shifter, an all solid state switching device, can operate from 300 K to 3K. The phase shifter is capable of switching the polarization state of linearly polarized microwave or millimeter-wave radiation in a waveguide at high switch rates. It can be used to switch the phase of the electric field inside a waveguide by 180° by inverting the polarization state of the field. The device can produce a constant phase shift for frequencies over a very wide fractional band (30%) within which its performance specifications remain substantially uniform.

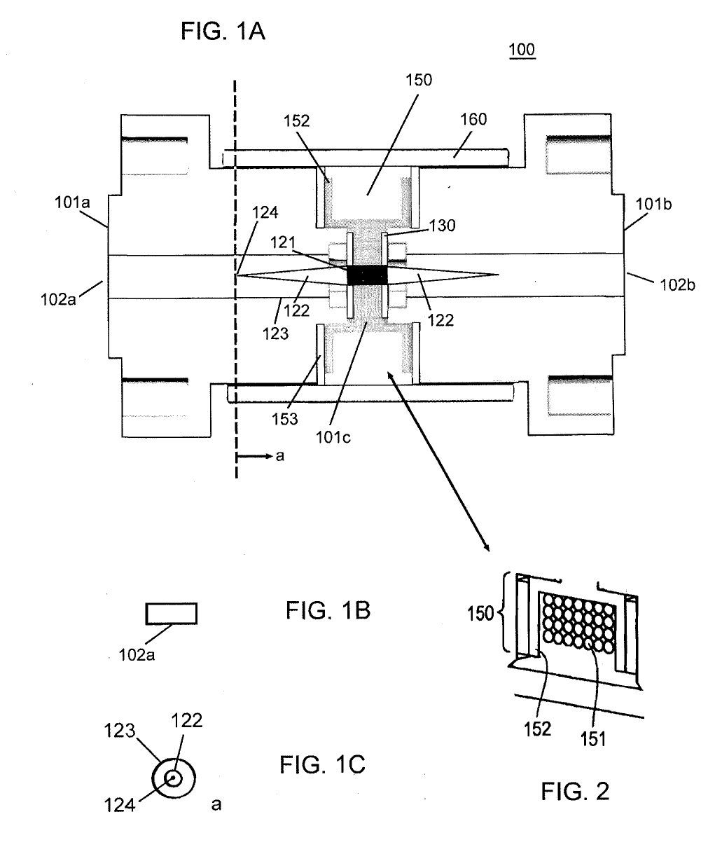

FIG. 1 shows a schematic diagram of an exemplary 180° phase shifter according to the present invention. Microwave radiation enters through one of the rectangular ports 102a or 102b, is phase shifted in the ferrite by 180°, and leaves through the other rectangular port (102a or 102b). The inventive polarization switch 100 is based in part on Faraday rotation and is referred to herein interchangeably as a Faraday rotation switch (FRS). A related device, a polarization modulator having a corrugated waveguide structure, the Faraday rotation modulator (FRM), was described in U.S. patent application Ser. No. 11/450,753, “Wide-bandwidth polarization modulator for microwave and mm-wavelengths”, filed Jun. 9, 2006 by the same inventor, Brian Keating, and published as U.S. Published Patent Application No. 2006/0279373. The Ser. No. 11/450,753 application is hereby incorporated herein by reference in its entirety.

The exemplary phase shifter of FIG. 1A is now described in more detail. As used herein, the term “rectangular waveguide” refers to the shape of the internal cross section of a waveguide as viewed along its longitudinal axis (which can also be a square), and has no significance for the shape of the overall exterior surface of the device comprising the waveguide, which may in fact have a circular cross section, or a cross section having any other convenient shape. A rectangular metallic waveguide comprising rectangular waveguide sections 101a and 101b can be machined or formed from a metallic material. Suitable metals for rectangular waveguide sections 101a and 101b include aluminum, and copper, such as a gold plated electroformed copper. Rectangular waveguide sections 101a and 101b when made from a metal such as copper will exhibit a finite loss, even at cold temperatures. For ultra low signal level applications, such as some astronomical applications where low loss is important, rectangular waveguide sections 101a and 101b can be fabricated from a superconductor, such as niobium (or intermetallic alloys of niobium, such as niobium-tin or niobium titanium) that can be made superconducting at cryogenic temperatures. Rectangular metallic waveguide sections 101a and 101b are separated by a dielectric break 101c. In some embodiments, rectangular metallic waveguide sections 101a and 101b can also include end flanges (not shown in the cutaway drawing for simplicity) to mechanically couple the polarization switch to the flange of an input and/or an output waveguide (not shown).

A central structure 120 (interchangeably referred to herein as a “toothpick”) includes cylinder 121 and two ceramic tapered cones 122 mechanically affixed to cylinder 121 for impedance matching to cylinder 121. Cylinder 121 can comprise any dielectric material exhibiting a suitable Faraday rotation at wavelengths of interest, such as mm-microwave wavelengths. Cylinder 121 typically has a permeability (magnetic permeability) greater than the permeability of a vacuum. Ceramic tapered cones 122 can comprise an alumina ceramic. While the exemplary polarization switches discussed herein were built and tested using ferrite cylinders, other ceramic and non-ceramic dielectrics are thought to be suitable for use in such devices as well. For example, the Faraday Effect has been shown to exist in n type doped germanium. (G. Srivastava and P. Kothari, “Microwave Faraday effect in n type germanium”, J. Phys. D: Appl. Phys., Vol. 5, 1972, GB). It is contemplated that cylinder 121 can be made from various types of semiconductor materials, including a number of doped garnet semiconductors as manufactured by the Trans-Tech, Inc. of Adamstown, Md.

Note that a central structure can include shapes other than the cylinder and two tapered cones of the embodiment described above. For example, a similar type of central structure can include a structure having a cross section including a polygon having N sides having a permeability greater than that of vacuum. Such a structure can have a cross section including a polygon having N sides (where N is an integer) having two end faces situated in a perpendicular orientation to a longitudinal axis of the structure having a cross section including a polygon having N sides, and two dielectric pyramidal structures having N sides. Each of the dielectric pyramidal structures can have N sides having a base mechanically coupled to an end face of the structure having a cross section including a polygon having N sides and having an axis situated substantially collinearly with the longitudinal axis of the structure having a cross section including a polygon having N sides. Such a central structure can be supported substantially in the center of the interior opening of a predefined cross-sectional shape of the waveguide. The structure can have a cross section including a polygon having N sides substantially situated within the dielectric break of the waveguide. In some embodiments, N equals 4 or an integer multiple of 4.

Toothpick 120 can be held substantially center aligned along the longitudinal axis of the openings of rectangular waveguide sections 101a and 101b and supported by one or more insulating members, such as insulating members 130. FIG. 1A shows an embodiment where two insulating members 130 support toothpick 120 inside of a center cylindrical opening of rectangular waveguide sections 101a and 101b substantially along the central longitudinal waveguide axis. In some embodiments, the insulators can be silica washers. Note that in a preferred embodiment, cylinder 121 is aligned substantially within dielectric break 101c between waveguide sections 101a and 101b. Cylinder 121 can be subject to a magnetic field of controllable magnetic strength provided by a magnetic source in order to achieve polarization switching.

FIG. 1B shows an end on view of a rectangular waveguide port 102a. Note that while rectangular waveguide sections 101a and 101b have rectangular openings to a rectangular waveguide section, in most embodiments, there follows a transition to another shaped waveguide that surrounds and houses toothpick 120. Typically toothpick 120 resides within a section of circular waveguide. Thus, in some embodiments, the overall FRS waveguide structure can be viewed substantially as a coaxially dielectric filled waveguide having rectangular waveguide transitions at each end. FIG. 1C shows an end on view looking from the dotted line of FIG. 1A in a direction “a” onto the tip 124 of a toothpick 120 supported in a circular waveguide section. Depending on a desired electromagnetic wave mode, other suitable shaped waveguides can be used with a toothpick 120. Suitable shapes include square, hexagonal, and other polygon shapes. The rectangular waveguides of rectangular waveguide sections 101a and 101b are typically at least 3 to 5 wavelengths in length along their longitudinal (direction of propagation) axis. A transition to any suitable shaped waveguide surrounding toothpick 120 follows. Generally the transition to another waveguide shape (such as a smooth cylinder) is made by the tip 124 of toothpick 120. Such waveguide shape transitions can be smooth and substantially continuous analogous to one waveguide shape “morphing” into another shape, e.g. rectangular to circular, or abrupt, such as one waveguide shape “butted” onto another waveguide shape.

FIG. 2 shows one exemplary embodiment of a suitable phase shifter solenoid that can act as the magnetic source. As show in more detail in FIG. 2, solenoid assembly 150 comprises one or more windings 151. An electric current from power source (power source not shown in FIG. 2) can be applied to solenoid assembly 150 through any type of suitable electrical terminals, wires, contacts, or connectors (not shown). Absorber 152 can absorb stray electric fields that might cause cavity resonance losses or otherwise distort the desired electric field distribution. Ideally the dielectric waveguide would not be surrounded by any metal. However, since it is convenient to use various metals in a FRS, an absorbing dielectric can substantially prevent the field from penetrating into the coil form and into metal solenoid coil wires 151. Coil bobbin 153 can also be made from a non-absorbing, but easily machined material such as Aluminum Nitride. An absorber 152 can be applied to one or more surfaces of a coil bobbin 153. For example, the inside surface of a coil bobbin 153 can be coated with a microwave absorber. Suitable coatings include castable Eccosorb, CR-117, manufactured by Emerson & Cuming Microwave Products, Inc. of Randolph, Mass.

A yoke 160 and pole pieces 153 can create a magnetic shield. In embodiments including solenoid 150, it is advisable to shield solenoid 150. One reason is to prevent the solenoid 150 AC magnetic field from inducing electrical currents into nearby conductors and to avoid eddy currents in nearby conductive structures. Also, as discussed later, polarization switches can be used independently in array applications involving a plurality of switches 100 where it can be important to prevent switches 100 from interacting with each other. Also, certain types of detectors and amplifiers, such as Transition Edge Superconducting Bolometers and SQUID amplifiers which can be used with polarization switches in some applications can be magnetically sensitive and need to be shielded. Such devices need to be shielded from the earth's field, let alone from solenoids 150 in nearby polarization switches 100, which can be a thousand or more times larger than the Earth's magnetic field. Moreover, coupling between devices can be exacerbated by the AC field from the polarization switch solenoid 150 (as compared to the Earth's DC magnetic field). Because the electromagnetic waves to be phase-shifted need to propagate into and out of phase shifter 100, the shielding cannot fully enclose polarization switch 100, i.e., there cannot be a complete Faraday cage. However, the combination of yoke 160 (typically a cylindrical shell) and pole pieces 153 (essentially washers which come as close to the waveguide as possible) can provide substantial shielding while still allowing entry and exit of signals of interest through the input and output signal ports (FIGS. 1A, 102a and 102b). In low noise cryogenic applications, shielding materials should be magnetically permeable as well as useable at low temperatures. One suitable proprietary material, called Cryoperm, manufactured by Vacuumschmelze of Hanau, Germany, can be post production annealed and then fabricated into yoke 160 and pole pieces 153. Such post process annealing can be performed by companies such as the Amuneal Manufacturing Corp. of Philadelphia, Pa. Yoke 160 can also include one or more small slots or openings to allow electrical wires from solenoid 150 to pass to the outside for electrical connection to a suitable driving electrical current.

In operation, an incoming electromagnetic wave is propagated into a first section of rectangular waveguide section, such as rectangular waveguide section 101a via port 102a, and coupled into dielectric cylinder 121 via a first ceramic cone 122. The polarization of the incoming electromagnetic wave can be switched by a polarization switching angle as it passes through dielectric cylinder 121 by Faraday polarization rotation according to a magnetic field as caused by the one or more windings 151 of solenoid 150. The electromagnetic wave then continues to propagate out of cylinder 121 via a second ceramic cone 122 and a second section of rectangular waveguide section 101b. The output polarized electromagnetic wave can have a final polarization ranging from no polarization change relative to the incoming signal polarization (for example at zero solenoid 150 current) or to a polarization rotation as the result of polarization switching (non-zero solenoid 150 current). The output signal can be coupled via port 102b out of polarization switch 100 though air typically into another waveguide. Note that for linear polarization, integer multiples of π rotation are equivalent to no rotation.

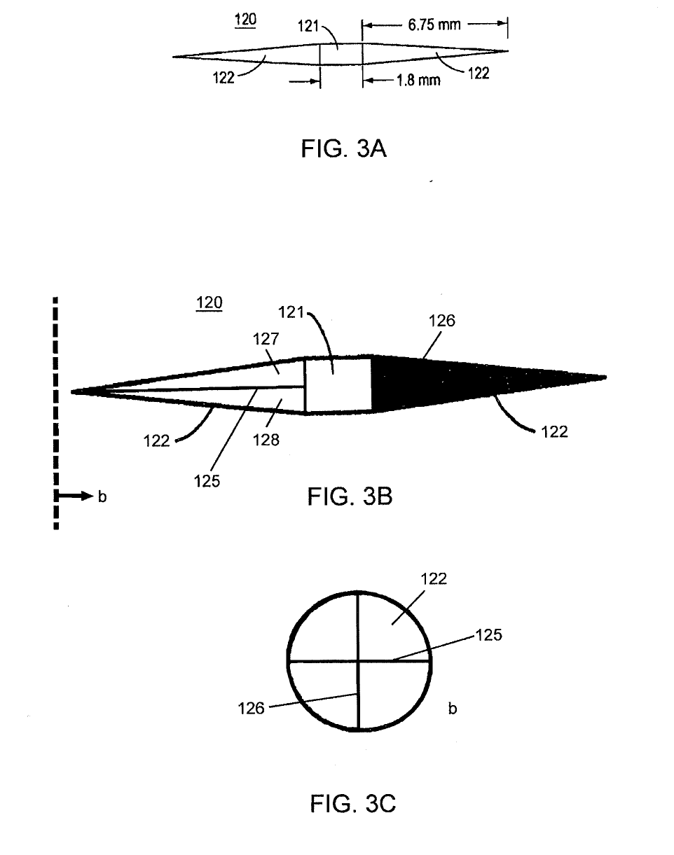

FIG. 3A shows a black and white rendition of a toothpick 120 having, in one exemplary embodiment, alumina ceramic cones 122 and a ferrite cylinder 121. Note that the edges of cones 122 are substantially smooth and that any apparent irregularities are an artifact of the FIG. 3A rendition. Part of the optimization process to maximize transmission, particularly where the dielectric constant of cones 122 is different than the dielectric constant of cylinder 121, can include a determination of the optimum ratio of cone 122 base diameter to the ferrite cylindrical 121 diameter. This ratio can be used to improve the impedance match into cylinder 121. For example, where the dielectric constant of cylinder 121 is greater than the dielectric constant of cone 122, cone 122 base diameter can typically be less than the diameter of cylinder 121.

In some embodiments of a FRS, a toothpick 120 can include “sandwiched” sections of a microwave absorbing material such as a metal or metallization layer within cones 122. For example, FIG. 3B shows a toothpick 120 having a sheet of material in each cone 122. (Note that a part of the right side of cone 122 towards the front surface of the page is shown as a “cutaway” representation thus exposing the material layer 126 for illustrative purposes.) The planes of material in the cones 122 are typically oriented substantially 90 degrees with respect to each other about the longitudinal axis of toothpick 120. FIG. 3C shows a representative end on view from the dotted line of FIG. 3B in the “b” direction to illustrate the relative orientation of two exemplary material layers 125 and 126. (Cylinder 121 is ignored for simplicity, as transparent, in the representative view of FIG. 3C). The sheets can be created by vapor deposition or can be created by inserting a thin section of material sheet. The sheets can be made of any suitable microwave absorbing material. Suitable materials include metals such as aluminum, bismuth, tungsten. Also, an epoxy such as ECCOSORB® (available from Emerson & Cuming Microwave Products, Inc. of Randolph, Mass.) can be used as the microwave absorbing sheet. Such epoxies and similar materials can be sprayed or painted onto a machined or otherwise formed internal surface of cone 122. In such FRS embodiments, material layers 125 and 126 act as a mode filter absorbing microwave radiation having undesired polarization (misaligned portions of the electromagnetic radiation).

Any suitable magnetic field can be used to cause a polarization switching angle. The controlling field does not-need to be provided by a solenoid such as solenoid 150 fixed in a cutout along the outside surface of rectangular waveguide sections 101a and 101b, as shown in FIG. 1A. In various embodiments, the windings 151 can comprise conventional magnet wire, cooled magnet wire (such as a water or liquid cooled conductor), or the magnet windings can comprise superconducting magnet wire to minimize self heating which is particularly advantageous in a cryogenic detector application. The inventive polarization switch can operate from elevated temperatures through room temperature and down to substantially zero Kelvin. Note however that in some embodiments, FRS operation over temperature can be limited if the designed magnetic field distribution cannot be attained where the magnetic permeability of cylinder 121 is significantly reduced at higher temperatures.

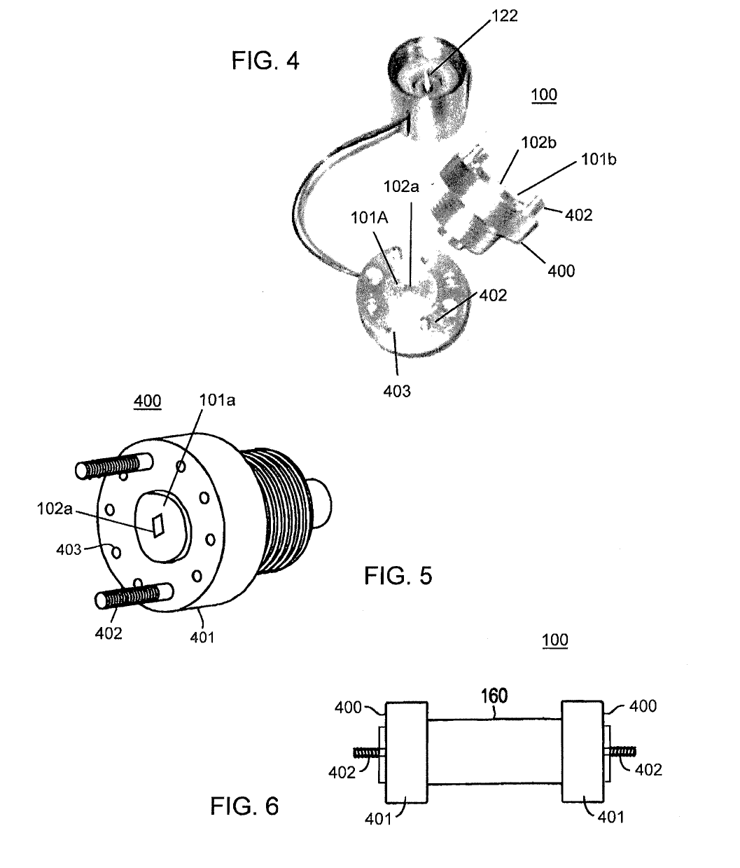

FIG. 4 shows one embodiment of a disassembled Faraday rotation switch (FRS). FIG. 5 shows more detail of a waveguide assembly 400 of an FRS, such as that shown in FIG. 4. Rectangular waveguide port 102a is typically situated substantially in the middle of an outer surface of waveguide flange 401. A waveguide assembly 400 can be mechanically coupled to a mating waveguide flange on another component (e.g. a microwave feedhorn, not shown) via threaded studs 402 and/or threaded holes 403. FIG. 6 shows a simplified diagram of a side view of an FRS including a yoke 160 (see also FIG. 1A), such as that shown in FIG. 4.

Phase shifting devices and techniques of the prior art typically insert a constant path length to obtain a fixed amount of phase shift when a switch in the “on” state. Such correspondence between extra path length and degree of phase shift is inherently bandwidth dependent due to the one-to-one relationship between extra path length and degree of phase shift. Thus, a given path length produces a 180° phase shift for only one frequency. Therefore, manufacturers of such devices typically produce a specific path length required for the center of a specified frequency band. Unfortunately, such prior art devices also exhibit an undesirable maximal phase deviation from 180° at the band edges. By contrast, the inventive FRS device, for a 30% fractional bandwidth, can exhibit a relatively small deviation of typically 3° at each of the band edges. Because of its frequency-independent phase shift mechanism (Faraday Effect), a FRS phase shifter can also produce a uniform phase shift with deviations less than 0.1° across the band.

Note that Faraday rotation has been previously used in static microwave devices. However, in such static applications, only one phase or polarization state is used. Microwave isolators, for example, use only a DC magnetic field, typically supplied by a permanent magnet. Inherently non-switched DC field devices, such as isolators, are not suitable for switched phase applications.

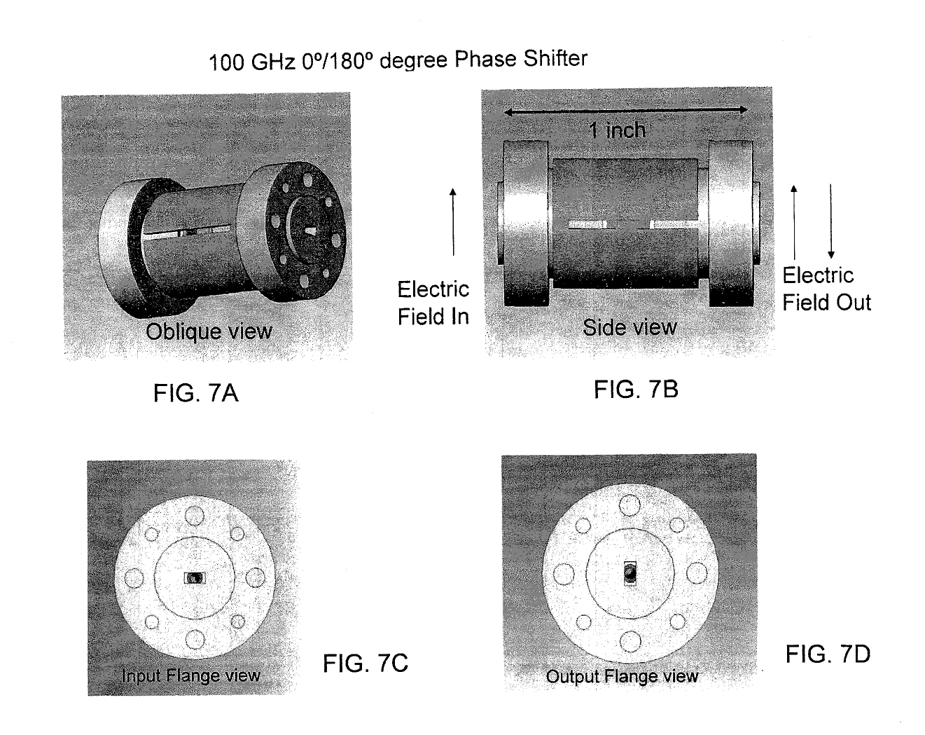

FIG. 7A shows an oblique view of an exemplary 100 GHz 0°/180° FRS device. FIG. 7B shows a side view of the FRS of FIG. 7A. FIG. 7C shows an input flange view of the FRS of FIG. 7A. FIG. 7D shows an output flange view of the FRS of FIG. 7A. For frequencies in the microwave or millimeter bands, the phase can be switched at kHz rates.

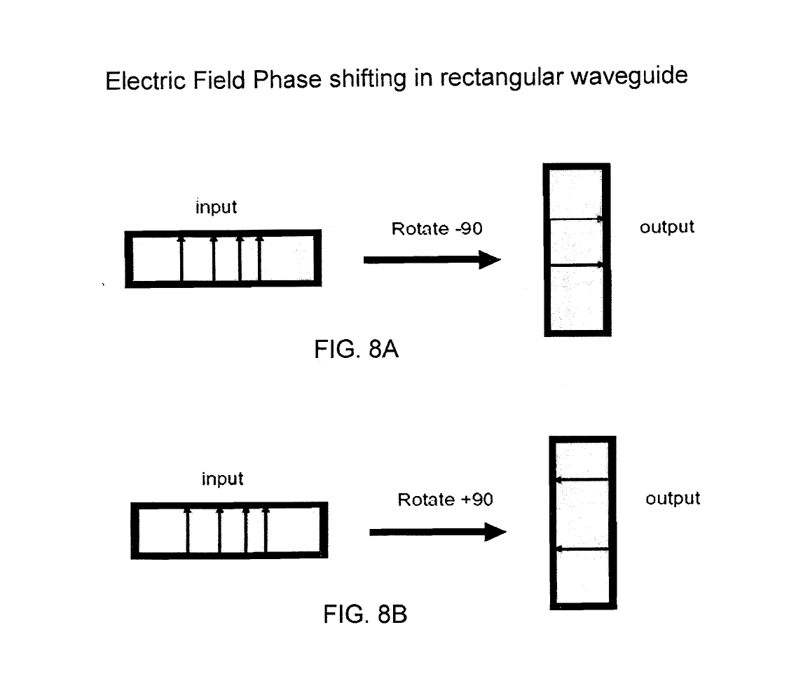

FIG. 8A and FIG. 8B are vector field line drawings that show electric field phase shifting using the rectangular waveguides of an FRS as shown in FIG. 7A. The FRS device accomplishes phase shift switching, such as 180° phase shifting, by rotating the electric field vector's polarization inside a magnetized ferrite in waveguide (Faraday rotation). This type of Faraday rotation is naturally broadband. In FIG. 8A, for example, there is a −1 phase shift, or a rotation of −90 degrees of the electric field. A −1 phase shift is equivalent to a 0 degree phase shift. In FIG. 8B, there is a +1 phase shift, or a rotation of +90 degrees, which is equivalent to a 180 degree phase shift.

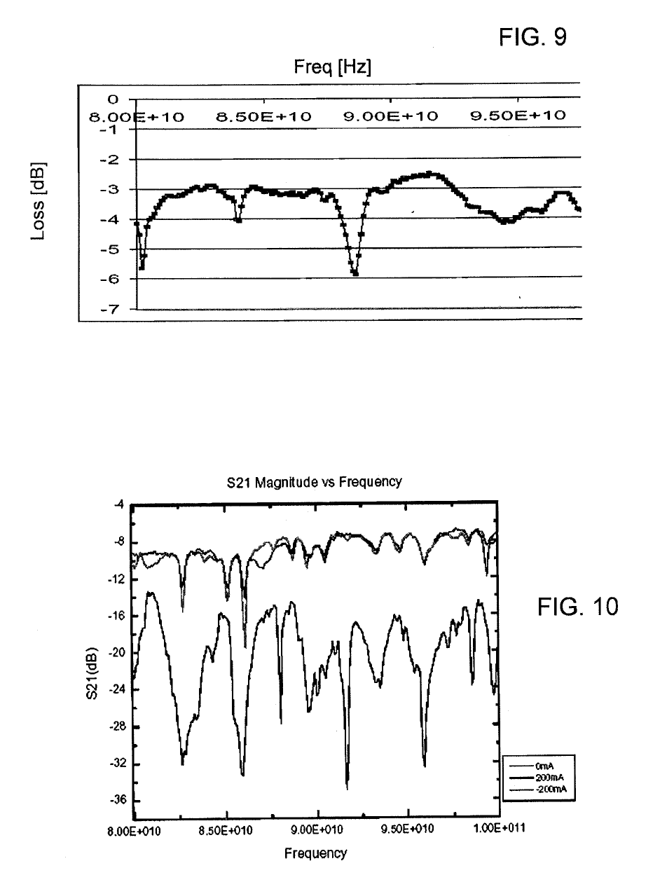

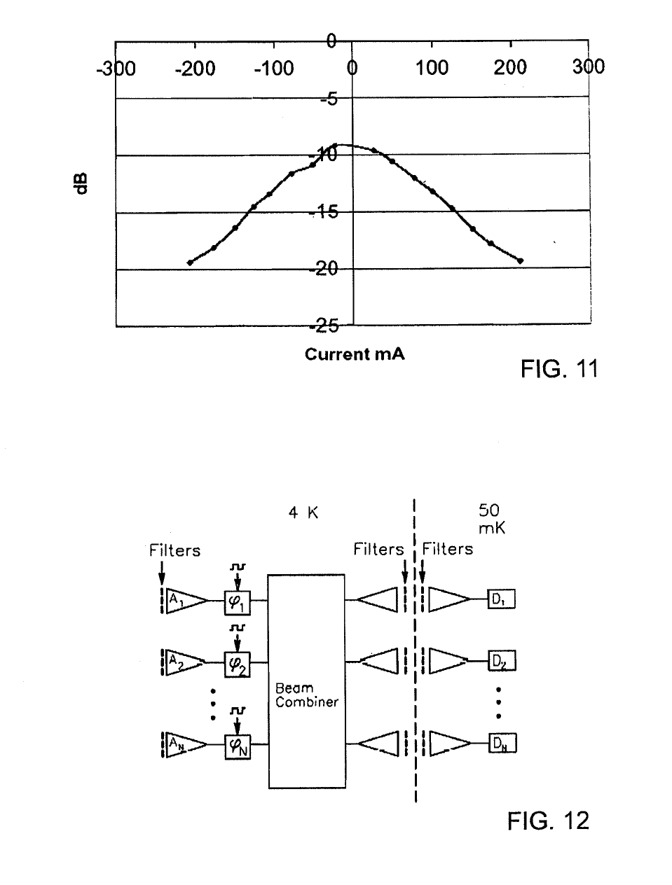

FIG. 9 shows a graph of insertion loss for a 100 GHz FRS at room temperature. FIG. 10 shows a FRS transmission switch ratio graph of S21 versus frequency. The S21 amplitude is shown as a relative normalized transmission in dB. The upper curves show the switch “ON” with a +200 mA or −200 mA solenoid current. The lower curve shows relative transmission at a zero solenoid current. FIG. 11 shows a graph of reflection versus current applied to an exemplary FRS. Here, 20 dB corresponds to 1% of the reflected power.

The benefits of phase sensitive detection can be further utilized where the phase of the electric field is AC modulated. In such AC switching (between 0° and 180°), the electric field changes sign at the switch rate that can be useful for synthesizing beams. Also, because constant sources of noise are subtracted out, AC switching can be used to encode a signal with a very high common mode rejection ratio.

A prototype phase shifter has been constructed that can rotate the electric field vectors by ±80° (160° total) at 4 K. Even with 160° rotation instead of 180°, the electric filed has a large negative component and the device functions as a ± phase shift, albeit with slightly increase loss compared with the 180° that can ultimately be produced. Failure of the current device to achieve 180° was attributed to the inadequacy of the test stand cryogenic set-up, not as a fundamental limitation of the device. The initial performance measurements successfully demonstrated the FRS principle, a switch ratio (on transmission divided by off transmission is equal to 10 over a 20 GHz band pass), with very low reflection (1%) for the 100 GHz prototype at 4 K. With an upgraded cryostat, it is expected that this ratio will be close to 100.

The FRS phase shifter as described herein can be used as a component in an interferometer. An interferometer includes a group of two or more antennae in which the relative phases of the respective signals feeding the antennae are varied in such a way as to produce a radiation pattern that is strongly reinforced in a desired direction and suppressed in undesired directions. Such radiation patterns allow a beam to be synthesized and scanned rapidly to/from any desired direction. Also, since the inventive phase shifter operates in waveguide modes instead of relying suspended stripline technology, it can typically be inserted into a receiver before any other components, thus greatly reducing the amount of excess noise and/or loss typically associated with prior art techniques. FIG. 12 shows an exemplary block diagram of an interferometer using FRS devices as described herein. The phase shifters can be digitally controlled between 0 and 180 degrees. Note that in this exemplary interferometer, the FRS devices have been placed prior to signal combination (interference) and before the bolometer detectors.

An interferometer also typically includes a processor configured to receive an output signal from each of a plurality of detectors. Each detector generally has one or more detector electrical output terminals. The output signals can be combined and processed to strongly enhance an incident electromagnetic wave from a particular direction. While much of the front end processing today is typically accomplished by analog processing, as digital electronic components become faster, it is contemplated that such processing could include analog and/or digital processing.

Since inventive phase shifter includes an all solid state design with no moving parts, no maintenance is required. Therefore, the inventive phase shifter offers a significant advantage for use in inaccessible environments such as in satellites, polarimetric remote sensing, and focal planes of large diameter communications transceivers, e.g., NASA's Deep Space Network. With slight modifications, the power handling capability of the device, for radar systems, can be several watts and the power required to achieve polarization switching is extremely low (a few milli Watts) when cooled below 10 K and a few Watts at room temperature. The inventive FRS phase shifter technology is therefore also naturally suited to extreme environments (low temperature and high vacuum), and possesses ideal characteristics for remote sensing components.

Beyond receiver applications of the phase shifter of the present invention, additional remote sensing applications include phased-array planar antennae (which operate similar to interferometers, but “in reverse”, i.e., they broadcast rather than receive). This allows satellites and ground stations to achieve high directivity with small antennae.

What is claimed is:

1. A phase shifting device for switching the polarization state of an electromagnetic wave comprising:
a waveguide having two waveguide sections, each waveguide section having an exterior rectangular opening defined in an end surface thereof and having an interior opening of predefined cross-sectional shape defined within a body thereof, said exterior rectangular opening and said interior opening of predefined cross-sectional shape situated along a longitudinal axis of said waveguide, said waveguide sections separated by a dielectric break, said dielectric break defined therein and situated substantially collinearly with said longitudinal axis of said waveguide in substantially a center of said waveguide;
a central structure situated along said longitudinal axis of said waveguide, said central structure including a cylinder having a permeability greater than that of vacuum, said cylinder having two substantially circular end faces situated in perpendicular orientation to a longitudinal axis of said cylinder, and two dielectric cones, each of said dielectric cones having a base mechanically coupled to an end face of said cylinder and a cone axis situated substantially collinearly with said longitudinal axis of said cylinder, said central structure supported substantially in said center of said interior opening of predefined cross-sectional shape of said waveguide, said cylinder substantially situated within said dielectric break of said waveguide; and
a magnetic field source, said magnetic field source configured to generate a controllable magnetic field in said cylinder, wherein said magnetic field switches a polarization of the electromagnetic wave causing a phase shift of the electromagnetic wave of substantially zero degrees when said controllable magnetic field is off and a pre-determined phase shift when said controllable magnetic field is on.

2. The device of claim 1, wherein said interior opening of predefined cross-sectional shape comprises a circular opening.

3. The device of claim 1, wherein said pre-determined phase shift is substantially 180 degrees.

4. The device of claim 1, wherein said pre-determined phase shift is constant to within 1 degree over a 30% or greater fractional bandwidth.

5. The device of claim 1, wherein said waveguide comprises gold plated copper.

6. The device of claim 1, wherein said waveguide comprises a superconductor material.

7. The device of claim 1, wherein said central structure is supported by one or more dielectric supports.

8. The device of claim 7, wherein said one or more dielectric supports comprise one or more silica washers.

9. The device of claim 1, wherein said ceramic cones comprise an alumina ceramic.

10. The device of claim 1, wherein each of said ceramic cones further comprise a sheet of microwave absorbing material comprising a plane having a first axis oriented along a longitudinal axis of said cylinder and a second axis oriented at substantially 90 degrees to said longitudinal axis of said cylinder, said respective second axis oriented substantially at 90 degrees of rotation about said longitudinal axis of said cylinder with respect to each other.

11. The device of claim 1, further comprising a microwave absorber.

12. The device of claim 11, wherein said dielectric break is coated with a microwave absorber.

13. The device of claim 1, wherein said magnetic field source comprises a solenoid having solenoid windings.

14. The device of claim 13, wherein said solenoid having solenoid windings comprises a selected one of metallic windings and superconducting windings.

15. The device of claim 1, wherein said dielectric cylinder comprises a ceramic or a semiconductor.

16. The device of claim 15, wherein said ceramic comprises a ferrite ceramic.

17. The device of claim 16, wherein said semiconductor comprises germanium or garnet.

18. An interferometer apparatus for strongly enhancing signal reception of an incident electromagnetic wave from a particular direction comprising:
two or more receiving structures to guide said incident electromagnetic wave into said interferometer apparatus;
two or more phase shifting devices according to claim 1, each phase shifting device coupled to one each of said receiving structures;
two or more detectors coupled to a respective one of said output structures of said two or more phase shifting devices, each detector having a detector electrical output terminal; and
a processor configured to receive an output signal from each of said detector electrical output terminals, wherein said output signals can be combined and processed to strongly enhance said incident electromagnetic wave from a particular direction.

19. The apparatus of claim 18 wherein at least one of said two or more detectors comprises a bolometer.

20. The apparatus of claim 18 wherein at least one of said two or more detectors comprises a microwave amplifier.

21. The apparatus of claim 18 wherein at least one of said two or more detectors comprises a SIS mixer.

22. The apparatus of claim 18 wherein said detector is cooled to a temperature below 100 K.

23. The apparatus of claim 18 wherein said magnetic field source is an electrical solenoid.

24. The apparatus of claim 23 wherein said electrical solenoid comprises superconducting windings.

25. The apparatus of claim 18 wherein at least one of said two or more receiving structures and said output structure comprises a microwave feedhorn.

26. A phased array apparatus for transmitting an electromagnetic wave in a particular direction comprising:
two or more input structures, each of said input structures configured to accept an electromagnetic wave to be transmitted by said phased array apparatus in a particular direction;
two or more phase shifting devices according to claim 1, each phase shifting device coupled to one of said input structures to receive an input signal therefrom and configured to provide as output a respective phase shifted output signal; and
two or more transmitting structures, each of said transmitting structures operatively connected to a respective one of said phase shifting devices and configured to receive as input a respective phase shifted output signal from a respective one of said phase shifting devices, and configured to guide said phase shifted output signal from said phase shifting device into a transmission medium.

27. The phased array apparatus of claim 26, wherein said two or more transmitting structures comprise planar antennae.

28. A phase shifting device for switching the polarization state of an electromagnetic wave comprising:
a waveguide having two waveguide sections, each waveguide section having an exterior rectangular opening defined in an end surface thereof and having an interior opening of predefined cross-sectional shape defined within a body thereof, said exterior rectangular opening and said interior opening of predefined cross-sectional shape situated along a longitudinal axis of said waveguide, said waveguide sections separated by a dielectric break, said dielectric break defined therein and situated substantially collinearly with said longitudinal axis of said waveguide in substantially a center of said waveguide;
a central structure situated along said longitudinal axis of said waveguide, said central structure including a structure having a cross section comprising a polygon having N sides having a permeability greater than that of vacuum, said structure having a cross section comprising a polygon having N sides having two end faces situated in perpendicular orientation to a longitudinal axis of said structure having a cross section comprising a polygon having N sides, and two dielectric pyramidal structures having N sides, each of said dielectric pyramidal structures having N sides having a base mechanically coupled to an end face of said structure having a cross section comprising a polygon having N sides and having an axis situated substantially collinearly with said longitudinal axis of said structure having a cross section comprising a polygon having N sides, said central structure supported substantially in said center of said interior opening of predefined cross-sectional shape of said waveguide, said structure having a cross section comprising a polygon having N sides substantially situated within said dielectric break of said waveguide; and
a magnetic field source, said magnetic field source configured to generate a controllable magnetic field in said structure having a cross section comprising a polygon having N sides, wherein said magnetic field switches a polarization of the electromagnetic wave causing a phase shift of the electromagnetic wave of substantially zero degrees when said controllable magnetic field is off and a pre-determined phase shift when said controllable magnetic field is on.

29. The phase shifting device of claim 28, wherein N equals 4.
